(19) United States
(12) Patent Application Publication
(10) Pub. No.: US 2005/0267795 A1
(43) Pub. Date: Dec. 1, 2005

(54) Dynamically assembling business process models

(75) Inventors: Zhong Tian, Beijing (CN); Jun Zhu, Beijing (CN); Jian Wang, Beijing (CN); Hai Qi Liang, Beijing (CN); Wei Ding, Beijing (CN)

Correspondence Address: LOUIS PAUL HERZBERG, 3 CLOVERDALE LANE, MONSEY, NY, 10952, US

(73) Assignee: International Business Machines Corporation, Armonk, NY (US)

(21) Appl. No.: 11/138,539

(22) Filed: May 26, 2005

(30) Foreign Application Priority Data
May 28, 2004 (EP) 200410047289.9

(51) Int. Cl. G06F 17/60

(52) U.S. Cl. 705/10; 705/80

(57) ABSTRACT

Apparatus and methods for dynamically assembling a business process model. An apparatus is configured in a company terminal connected with a network, and has a model building unit for building a business process model for the company, characterized in that the apparatus further includes: a retrieving unit for retrieving to obtain the business process model of other company from the network, and an assembling unit for assembling the business process model of the company with that of the other company to obtain an integrated business process model.

### TECHNICAL FIELD

The present invention generally relates to an apparatus and method of business collaboration in e-business, particularly to an apparatus and method for dynamically assembling business process models in a large scale e-business network environment.

### BACKGROUND ART

Dynamic e-business collaboration through integration approach is an art being explored by large number of information technology and service firms. In a dynamic business environment, requirement and provision relationship are mostly driven by each individual business case itself. Instead of the prevailing fixed and long-term partner relationship, short-term and dynamic coalition among partners will become the main stream. Key challenge for this new business mode lies in how parishioners can benefit from the ad-hoc and dynamic relationship, or from another perspective how we can guarantee the anticipated cost reduction and efficiency boost to interested companies.

For companies to fully automate and streamline the whole collaboration lifecycle, an apparatus and method being able to justify, promote and practice this new e-business approach is needed. One challenge for the apparatus and method lies in how we can guarantee execution efficiency and effectiveness in a large scale e-business environment by eliminating potential yet common business/IT problems among partners prior to real execution.

Some existing methods have been proposed by different companies and organizations to solve this problem. For example, the ebXML (e-business Extensible Markup Language) standard initiative defines the “modelling- publish- discovery-exchange” cycle for doing online B2B transactions. Each collaborative party will create and publish CPP (Collaborative Party Protocol) to specify its business capabilities and supported interaction protocols. A CPA (Collaborative Party Agreement) is achieved after negotiation among parties to define the constitution of the alliance, also the interaction protocols all parties agreed upon. Link to processes specification is allowed in CPP and CPA, while it is merely used as external supporting materials for the negotiation, and no support is provided by ebXML to find possible inconsistencies between different CPP from different parties. In most cases, understanding, verification and reconciliation of the process model among partners needs extensive human involvement and results in vast overhead in both time and money.

Some companies also try to solve the dynamic e-business relationship problems through Web service framework and related protocol family. WSDL (Web Service Definition Language) is used to define the service invocation interface exposed by a company. UDDI (Universal Description, Discovery and Integration) is used by a company to publish its business information, as well as its supported services, which can then be queried and retrieved by an interested potential collaboration party.

The object of UDDI technical committee is to develop the basic work regarding network business registration. UDDI specification forms an essential technical basis for publishing and finding a network implementation inside companies and between companies. The detailed information related to UDDI specifications and etc. can be found at the following web site:

| | |
|---|---|
| http:// | followed by: |
| www. | followed by: |

| | |
|---|---|
| oasis- open.org/committees/tc | followed by: |

_home.php?wg_abbrev=uddi-spec.

SOAP (Simple Object Access Protocol, enhanced by other standards like WSIF(Web Service Invocation Framework)) is then used to support invocation of the web services at runtime. The newly adopted BPEL (Business Process Execution Language) protocol is used to model the execution process of web services.

The major problem for these protocols is the lack of support in its procedure to enable business process verification and elimination of the existing problems therein before the execution phase. Many business process logic problems are not found until finally run into problems during the real execution phase of business collaboration. The logic conflicts between business processes of different partners are usually hard to be represented at the beginning phase and thus negotiation to solve conflicts becomes a long and inefficient work. All protocols above are defined at IT level and thus hard to represent business process related logics.

Most existing approaches for conducting negotiation between partners to solve business process level conflicts require all parties to join the discussion over a global business process model to avoid conflicts. They have the following disadvantages:
1) Hard and un-necessary to let all parties to have a global view of the integrated business execution logic;
2) Hard to find, represent and communicate business process conflicts among partners;
3) Inconvenient to gather all parties together at the same time to do face-to-face negotiation;
4) Unable apparently to support large scale business collaboration relationship, which may involves large number of partners.

### SUMMARY OF INVENTION

In order to solve the above existing problems, an aspect of the present invention is to provide an apparatus and method for enabling companies to prepare, establish, assemble, verify and execute business collaboration in a large scale e-business environment dynamically, high effectively and with low cost.

Therefore, the present invention provides an apparatus for dynamically assembling business process model, which is configured in a company terminal connected with a network. The apparatus comprises a model building unit for building a business process model for the company and is characterized in that the apparatus further comprises: a retrieving unit for retrieving the network to obtain the business process model of other company; and an assembling unit for assembling the business process model of the company with that of the other company to obtain an integrated business process model.

The present invention also provides a method of dynamically assembling business process model for establishing a business process model for a company in the company's network terminal and is characterized in that the method further comprises: a retrieving step of retrieving the network to obtain the business process model of other company; and an assembling step of assembling the business process model of the company with that of the other company to obtain an integrated business process model.

The present invention further provides a system for dynamically assembling a business process model in a large scale e-business network, comprising a plurality of apparatuses for dynamically assembling business process model, which are configured in a plurality of the company terminals connected through a network.

### BRIEF DESCRIPTION OF DRAWINGS

The other features and advantages of the present invention will become more apparent by describing in detail the embodiment of the present invention hereinafter in conjunction with the drawings, in which:

FIG. 1 is a block diagram of an apparatus for dynamically assembling a business process model in a large scale e-business network environment, which implements the present invention;

FIG. 2 is a schematic diagram illustrating the key points of the method of the present invention;

FIG. 3 is a schematic diagram illustrating a business process model;

FIG. 4 is a schematic diagram illustrating an integrated business process model formed by assembling two business process models together;

FIG. 5 is another schematic diagram illustrating an integrated business process model formed by assembling two business process models together;

FIG. 6 is a schematic diagram illustrating a conflict in the integrated business process model;

FIG. 7 is a schematic diagram illustrating a practical example that there is a conflict in the integrated business process model; and

FIG. 8 is another schematic diagram illustrating a practical example that there is a conflict in the integrated business process model.

### DESCRIPTION OF THE INVENTION

The present invention provides an apparatus and methods for enabling companies to prepare, establish, assemble, verify and execute business collaboration in a large scale e-business environment dynamically, high effectively and with low cost. An example is an apparatus for dynamically assembling business process model, which is configured in a company terminal connected with a network. An apparatus comprises a model building unit for building a business process model for the company and is characterized in that the apparatus further comprises: a retrieving unit for retrieving the network to obtain the business process model of other company; and an assembling unit for assembling the business process model of the company with that of the other company to obtain an integrated business process model.

In some embodiments, the apparatus further comprises: a publishing unit for publishing the business process model of the company over the network; a conflict detecting unit for simulating and analyzing the integrated business process model to detect whether there is a conflict therein, and when there is a conflict in the integrated business process model, generating a conflict report; and a conflict solving auxiliary unit for transmitting and/or receiving the conflict report to and/or from the other company through the network so as to facilitate the negotiation and solving of the conflict. In the present invention, the publishing unit publishes the business process model of the company to a UDDI registry in the network, and the retrieving unit retrieves and obtains from the UDDI registry the business process model of the other company.

The present invention also provides a method of dynamically assembling business process model for establishing a business process model for a company in the company's network terminal and is characterized in that the method further comprises: a retrieving step of retrieving the network to obtain the business process model of other company; and an assembling step of assembling the business process model of the company with that of the other company to obtain an integrated business process model.

In some embodiments, the method of the present invention further comprises: a publishing step of publishing the business process model of the company over the network; a conflict detecting step of simulating and analyzing the integrated business process model to detect whether there is a conflict therein, and when there is a conflict in the integrated business process model, generating a conflict report; and a conflict solving auxiliary step of transmitting and/or receiving the conflict report to and/or from the other company through the network so as to facilitate the negotiation and solving of the conflict.

In the method of the present invention, in the publishing step, the business process model of the company is published to a UDDI registry in the network, and in the retrieving step, the UDDI registry is retrieved and the business process model of the other company is obtained.

The present invention further provides a system for dynamically assembling a business process model in a large scale e-business network, comprising a plurality of apparatuses for dynamically assembling business process model, which are configured in a plurality of the company terminals connected through a network. The apparatus comprises a model building unit for building a business process model for the company configured with the apparatus and is characterized in that the apparatus further comprises: a retrieving unit for retrieving to obtain the business process model of other company from the network; an assembling unit for assembling the business process model of the company with that of the other company to obtain an integrated business process model; a conflict detecting unit for simulating and analyzing the integrated business process model to detect whether there is a conflict therein, and when there is a conflict in the integrated business process model, generating a conflict report; and a conflict solving auxiliary unit for transmitting and/or receiving the conflict report to and/or from the other company through the network so as to facilitate the negotiation and solving of the conflict.

A point of the present invention is its unique approach of letting each the company to define and publish its own business process and then dynamically exchange them with possible partners when a business opportunity arrives. The business process models are created in accordance with well-defined schemas and specifications to expose itself as a component to be connected with others. It may or may not include interaction related protocols the business will support, depending on what kind of verification and negotiation are expected to be done. The componentized models are then assembled by each partner from its own perspective to create an integrated model, which can then be simulated and analyzed to check the validity/ROI (Return of Investment) of performing e-business collaboration for the partners before actual execution phase.

The assembling and checking of process models can be done by each partner from its own perspective so that nobody needs to have a global view of all collaborative partners, which is hard to gain in large scale e-business environment. Key steps of the process are automated by algorithms in software or assisted by tooling with graphical user interfaces. The interface definition schemas and specifications enforce the validity of the process model and guarantee compatibility with other components within the integrated model.

Another element of the present invention is the enablement of sending/receiving of visualized conflict pinpoint report among business partners when some conflicts are detected in the integrated process model. With this approach, partners can do online negotiations to find ways to solve the business process level conflicts to go on with their e-business activities.

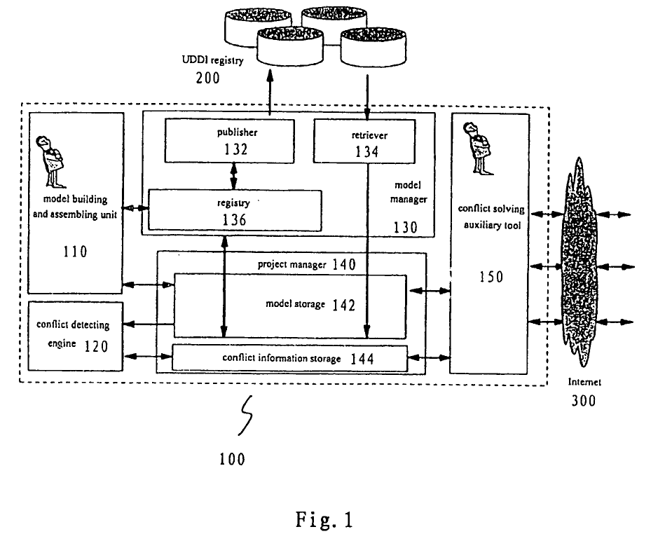

An example embodiment of the present invention will now be described in more detail in conjunction with the drawings. FIG. 1 is a block diagram of apparatus 100 for dynamically assembling a business process model, in which the present invention is applied. Apparatus 100 is a prototype implemented based on Java/XML technologies, which can be configured in the terminals of companies connected through a network. The terminal can be a general-purpose computer, and can also be a dedicated computing equipment integrating apparatus 100 of the present invention. At the same time, the terminal can comprise an input device such as a keyboard, a mouse, a tablet, a microphone and etc. for providing such information as input selection and confirmation. The terminal can also comprise an output device such as a display, a speaker and other output interface. In addition, the terminal comprises the common components that all computing devices have, such as CPU, RAM, ROM, data bus and command bus, for controlling and assisting the execution of the functional components of the present invention.

As seen from FIG. 1, the apparatus 100 is connected with Internet 300, and is connected with some well-known e-Marketplaces, which have for example UDDI registry 200. UDDI registry 200 can also be located on a network server (not shown). The network server (not shown) and UDDI registry 200 in the embodiment of the present invention are preferably located on the Internet 300.

The apparatus 100 in the present embodiment comprises: a model building and assembling unit 110 for building a business process model for the company, and connecting the business process models of different companies (potential partners) together to form a complete business process model (hereinafter referred to as “integrated business process model”). Here, the business process model can be categorized into an internal business process model and an interface business process model. The internal business process model refers to the business process that needs to be maintained inside the company itself, which is not assembled with the business process models of other company, nor published on the network, and is invisible for the other company. For simplicity, it is referred to as “the internal model (since it is not the key point of the present invention, this specification will not make detailed descriptions of it)”. The interface business process model is an important component that is assembled with the interface business process model that other potential collaborative the company (potential partner) publishes to obtain an integrated business process model. For simplicity, hereinafter the interface business process model is referred to as “the interface model”, and the integrated business process model is referred to as “the integrated model”.

In addition, the model building and assembling unit 110 can also be implemented as two different components for implementing respectively such two functions as building a business process model for a company and connecting the business process models of different companies together, so that the two functions do not have to be undertaken by the single component of model building and assembling unit 110.

Apparatus 100 in the present embodiment further comprises: a conflict detection engine 120 for simulating and analyzing (i.e., emulating) the integrated model created by the model building and assembling unit 110 before real execution, detecting whether or not there is a conflict therein, and generating a visualized conflict pinpoint report according to the detection result if there is a conflict. This kind of conflict pinpoint report can be one of text message, video image and audio message, or the combination thereof. Of course, other manners those skilled in the art can utilize and know may also be used to form the conflict pinpoint report.

Apparatus 100 in the present embodiment further comprises: a model manager 130 for storing and maintaining the internal model created by the model building and assembling unit 110, and for communicating with the external UDDI registry 200 so as to publish its own interface model onto the UDDI registry 200 or get the interface model of a potential partner from the UDDI registry 200, and maintaining and managing all of these models based on the UDDI mechanism.

Apparatus 100 in the present embodiment further comprises: a project manager 140 for creating, storing and managing a business collaboration project, wherein the business collaboration project comprises: the interface model of the company created by the model building and assembling unit 110, the interface model of the potential partner and the integrated model.

Apparatus 100 in the present embodiment further comprises: a conflict solving auxiliary tool 150 for publishing the conflict pinpoint report generated by the conflict detecting engine 120, and communicating with the potential partner through SMR (security message router) connected with the network 300, so as to negotiate and solve the conflicts among the models and rebuild models. The above potential partner is actually the other company that publishes other interface models constituting the integrated model. The above “communicating” includes the process that the conflict solving auxiliary tool 150 sends a conflict pinpoint report to the other company, and if necessary, receives the conflict pinpoint report from the other company.

The model manager 130 in the present embodiment comprises: a publisher 132 for publishing its own interface model onto the UDDI registry 200 through the network, and maintaining and managing the processes; retriever 134 for retrieving to obtain the interface model of other company through the network, i.e., fetch the interface model of the potential partner from the UDDI registry 200; and a registry 136 for storing and maintaining the internal model of the company created by the model building and assembling unit 110.

In addition, the project manager 140 in the present embodiment comprises: a model storage 142 which is a temporary storage of a business process model, for storing in the temporary storage its own related process models (including the internal model and the interface model) and the interface model of the potential partner obtained by retriever 134, and storing therein an assembly drawing which has established a connection (i.e., the integrated model); and a conflict information storage 144 for storing all the conflict information detected by the conflict detecting engine 120 and the generated visualized conflict pinpoint report.

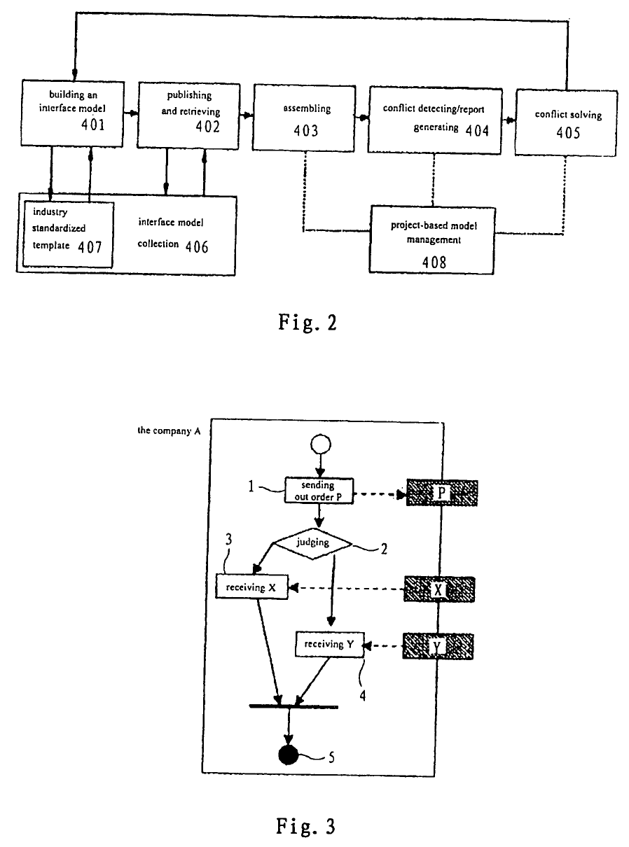

The method of the present invention will be described below with reference to FIG. 2, which is a schematic diagram of the key points of the method of the present invention. As seen from FIG. 2, the key points of the present invention comprise: building a business process model (block 401); retrieving to obtain other business process models from the network (block 402); assembling the business process model with the other business process models to obtain an integrated business process model (block 403). In block 402, the method of the present invention further comprises: publishing the business process model created by the company itself through the network. In addition, the present invention further comprises: simulating and analyzing the integrated business process model to detect whether or not there is a conflict therein, and generating a conflict report when it is detected that there is a conflict in the integrated business process model (block 404); and sending the conflict report to the other company through the network to negotiate and solve the conflict (block 405). Detailed descriptions for this will made below.

At block 401, each the company builds its individual business process model including the internal model and the interface model by using the model building and assembling unit 110, but its focus lies on building the interface model as a desired input/output model during the business collaboration execution. In this phase, the company can use a modeling tool (i.e. the model building and assembling unit 110) to create respective models from scratch, or leverage some existing industry standardized templates to create its business process model (as shown at block 407). Using the modeling tool can guarantee the business process model and template will follow some predefined schema and specification, so that models from different parties can be assembled as an integrated one (i.e. the integrated model). The input/output data format and etc. can also be included in the interface model. In addition, the industry standardized templates can be configured on the UDDI registry 200, or on the terminals of the companies.

The business process model built at block 401 can be shown in FIG. 3, in which an interface model of the company A is shown. As seen from FIG. 3, the company A sends out an order at node 1, and after the logic decision at node 2 and in case of meeting certain conditions, the required model data X are received at node 3, or in case of meeting another condition, the required model data Y are received at node 4. Then, the business result needed by the company A is formed by a predefined logic algorithm at node 5. As a result, the interface model forms interfaces 1′, 3′ and 4′, in which interfaces 3′ and 4′ are conditional interfaces.

In addition, the interface model may have the description information of the company which includes the information related to the company A such as the name, property, scale, business scope, address, contacting method of the company A. The description information can be recorded in the interface model in any data format that those skilled in the art can have in mind.

Of course, an interface is needed between the internal model and the interface model, yet since both the internal model and the interface model of the company are designed and completed by the personnel of the company, there will be no conflict problem described in the present invention between these interfaces. The interface of the internal model and that of the interface model can be designed with the same principle, or the internal model can be omitted and be created inside the interface model to form a unique business process model. In this case, there will be more complex logic relations and algorithms within the model.

At block 402, the company A uses publisher 132 to publish the created interface model onto a network server (not shown) or the UDDI registry 200 in the network through the Internet 300 or other network (including any large scale network that those skilled in the art can implement and execute e-business thereon). In the UDDI registry 200, the interface models of various potential partners having identical intention, interest or benefit are included (as shown in block 406 of FIG. 2). In the meantime, this interface model together with the description information of the company are then published onto the UDDI registry 200 (or certain public site on the Internet which is available) so that this interface model of the company A can be searched and found by other companies dynamically by applying certain criteria-based query.

The company A can also define some policy on whether or not other potential partner can retrieve its interface model, or whether or not the retrieval needs the approval of the company A publishing this interface model. For example, the interface model can be published within the entry of the company A in a revised UDDI registry 200 so that other companies need the approval of the company A (such as password verification) to retrieve and obtain the interface model of the company A.

When a business collaboration opportunity arrives, interface models are exchanged among possible business collaboration partners. Under a dynamic business environment, when the company A finds an opportunity and determines to find some partners to dynamically form a virtual project team, the retriever 134 will be used to browse certain public site on the Internet 300 and the UDDI registry 200 therein, and do query based on the requirement of the virtual project team to find a list of possible partners (not shown). The list can be located in the UDDI registry 200, and consists of the description information in the interface models published onto the UDDI registry 200 by companies. Each entry of the list can constitute a unique entrance of the interface model. Of course, the list can have other forms of different entrances. For example, the interface model can be invoked (obtained) by selecting the name, the business type and etc. of a company. Then, the company A can select one (or several) candidate B as potential partner based on certain credit information or other consideration (other conditions). According to the company B's policy, the company A either gets the company B's business process model directly from UDDI registry 200, or performs certain operations to get the company B's approval to obtain its model via request/response mode.

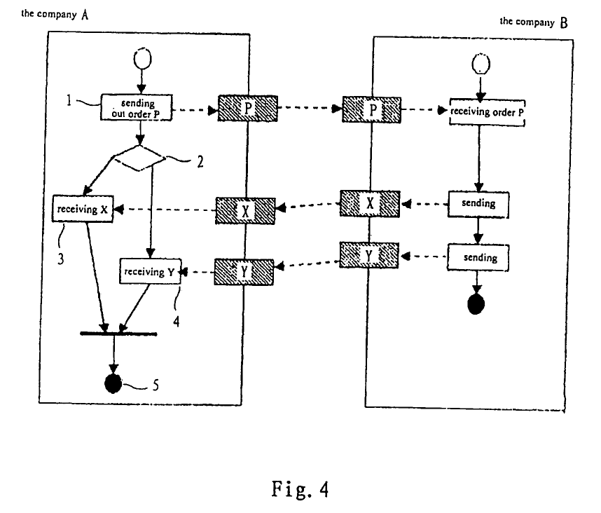

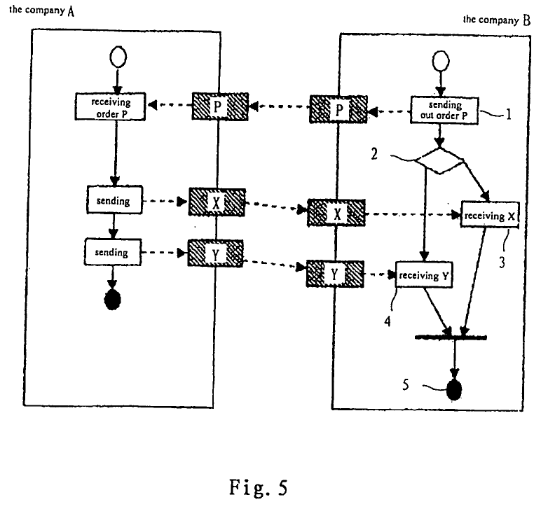

At block 403, the interface models of companies A and B are assembled together as an integrated one. In this process, the model building and assembling unit 110 can be utilized to use a software algorithm, so as to assemble the interface models of companies A and B, thereby forming the integrated model. The integrated model can be shown in one picture, as shown in FIGS. 4 and 5.

The mapping relationship between input/output of interface models can be automatically created under certain guides (such as ontology) of the computing environment. Of course it can be done by a human manually. The integrated model can be a global one that contains all related parties, if the scale for the virtual project team is limited. Yet for more common business collaborations under a large scale business environment, the assembling will be performed by each partner from its own perspective, requirement and view and contains only related models with it.

FIG. 4 shows an integrated business process model of companies A and B from the company A's own perspective. What is needed to explain here is that, when the assembly of the integrated model is considered from the company A's perspective, only the interface in the interface model of the company B is visible for the company A, but the internal logic in the interface model of the company B is invisible. When assembled together, the internal state or logic relation of the interface model of the company B shown in FIG. 4 is only an assumption based on its interface state. It has no effect on the execution of the integrated model, since during real execution or simulation the logic inside the interface model of the counterpart (i.e. the company B) does not need to be visible for other partners.

At the same time, the company B may also search for the company A's interface model by using retriever 134 configured in its terminal, then do assembling from its own perspective to form the integrated model of companies A and B assembled from the company B's perspective. At this time, for the company B, the internal state or logic of its own interface model is visible, while the internal state or logic of the company A is invisible.

At block 404, the integrated model is verified or simulated by using the conflict detecting engine 120 of apparatus 100. Possible conflicts or problems that may interfere with the future execution will be identified by applying software algorithm on the integrated model. These conflicts may include: data format inconsistency, resource waiting, flow inconsistency (i.e., flow structure dead-lock) and etc. At the same time, also we can do evaluation on the integrated model to propose the possible effects of the dynamic business relationship, i.e., to calculate the ROI for the business transaction.

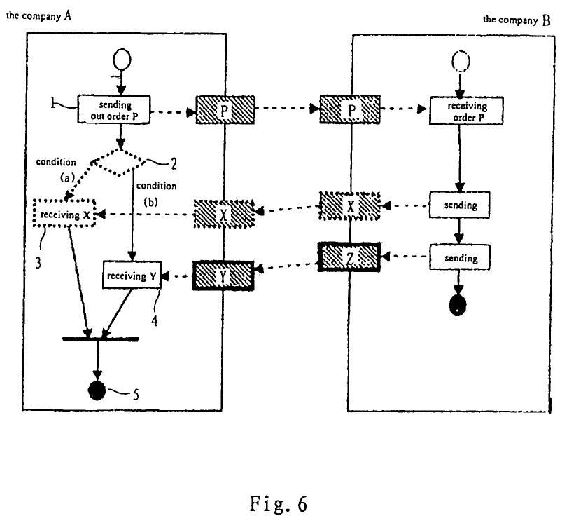

The detected conflict can be visualized with respect to the integrated model to point out where the problem is. For example, FIG. 6 illustrates the data format inconsistency and resource waiting conflicts detected in the integrated model of companies A and B. At the same time, a conflict pinpoint report can be generated based on the integrated model. As shown in FIG. 6, the detected data format inconsistency is that: a company hopes to receive resource data in the format of Y at node 4, yet the company B only sends out resource data in the format of Z. The detected resource waiting conflict in FIG. 6 is for example that: the company A requires to receive resource X under certain conditions at node 3, yet the company B always sends out resource X to the node. Therefore, under some other conditions, i.e., when certain conditions are not met so that it is unnecessary to receive resource X at node 3, a conflict occurs (there is no conflict under certain conditions, while there is a conflict under some other conditions, this can be regarded as a warning of conflict).

At the same time, the company B may also perform verification or simulation on the integrated model from its own perspective and generate a corresponding conflict pinpoint report.

The conflict pinpoint report can be a type of visualized mark including graphical and text information. It can also have such audio information as voice prompt to be presented through such an output device as display or microphone (not shown), so as to enable a user (i.e., a company) to visually determine the type, occurring location, etc. of the generated problem or conflict.

At block 405 of FIG. 2, the conflict pinpoint reports are exchanged between the terminals of companies by using the conflict solving auxiliary tool 150 in the apparatus 100. The related companies (partners) can try to solve various conflicts, especially business process level conflicts. If the verification or simulation fails, i.e., there occurs a problem or conflict, companies A and B will negotiate to see if both sides can adjust their own interface models to reach a compatible one. The conflict pinpoint reports can be exchanged through the conflict solving auxiliary tool 150 among all parties involved, who can understand the problem based on the visualized conflict mark. Then, based on the conflict pinpoint report, synchronous or asynchronous negotiation among partners can be carried out to find solution to the problems.

If the verification is successful, the related parties can go on with the execution of their business collaboration practically. Once the verification is successful, we can say many problems that may make trouble to the dynamic e-business transactions between companies A and B have been identified and eliminated. They can now enter into the phase of real execution. During the phase of real execution, when some on-the-fly problems are detected again, the whole lifecycle can still be executed to find problems and solve them. Of course, the possibility that some on-the-fly problems are detected again during the phase of real execution is very small.

As to an order (a project), it should be uniformly managed through the project manager 140 of apparatus 100 (as shown in block 408 of FIG. 2). The project manager 140 is used for creating, storing and managing each of the business collaboration projects, in which each business collaboration project includes the interface model of the company created by the model building and assembling unit 110, the interface model of a potential partner and the integrated model assembled, which are involved. The management of the project manager 140 may involve such processes as model modification, exchanging, assembling, verification and negotiation. Of course, sometimes this management process is conducted for many cycles to reach the final object, i.e. to reach an agreement or cancel the transaction finally.

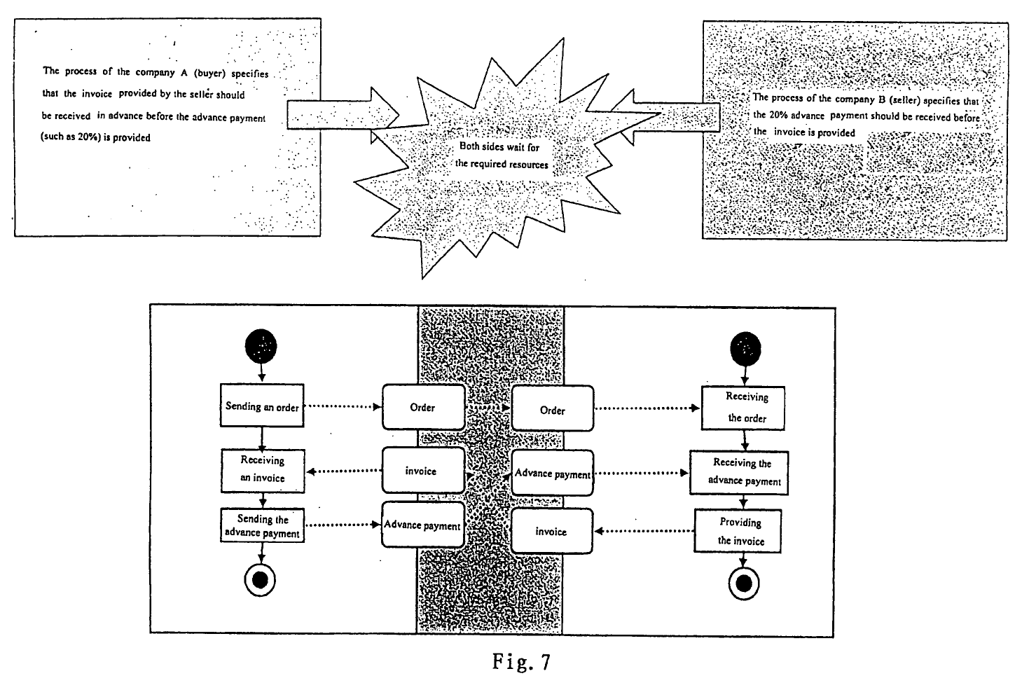

FIG. 7 is a schematic diagram of a practical example of the assembly of the interface models between two companies A and B. As shown in FIG. 7, in these models, the company A's business process is: sending out an order, then receiving the invoice of a potential partner (the company B), and then providing advance payment to the potential partner (the company B). The company B also has its own business process model in which the company B's business process is: receiving an order, then receiving the advance payment of the potential partner (the company A), and then providing the invoice to the potential partner (the company A). Herein, we can see that companies A and B's process models are different, in which a conflict in the process occurs.

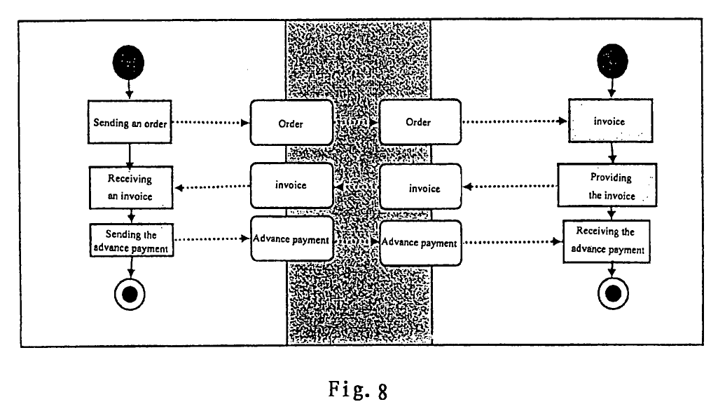

When the conflict detecting engine 120 of the company A detects the conflict during the verification or simulation of the interface model, a conflict pinpoint report is formed, and the conflict pinpoint report is sent to the company B by the conflict solving auxiliary tool 150. At this time, the companies A and B need to communicate with each other, one side of which needs to modify its interface model. Herein, we assume that the company B modifies its interface model into: receiving an order, then providing the invoice to the company A, and then receiving the advance payment of the company A. In this case, the situation is shown in FIG. 8, in which the interface models of the companies A and B coincide with each other completely, having eliminated the existing process conflict between them. Then, the companies A and B can go on with the collaboration of the project practically.

The above describes the methods and apparatus of the present invention only in terms of embodiments. By employing a method and apparatus of the present invention, the following advantages can be achieved:
1) Each business creates business process model based from its own perspective, individual models are assembled together to represent the interaction relationship between businesses, which satisfy the key requirement of doing dynamic e-business;
2) With who you are doing business is dynamically determined and nobody needs to have global knowledge of the whole virtual collaboration environment;
3) Business process models are published and exchanged with existing partners dynamically over the internet, the whole process are automated and thus save a lot of time and money;
4) Based on the integrated model, verification and simulation can be done at business level before the actually execution of the business processes, as a result efficiency and effectiveness of the lifecycle is greatly increased; and
5) With the integrated model assembled, it is much more convenient to identify and visualize process level conflicts between partners, so as to start the negotiation of the process conflict based on the conflict pinpoint of the integrated model.

In addition, the apparatus and method provided in the present invention can be implemented not only by software code (i.e., computer program) but also by a dedicated hardware integrating the functions of the present invention. At the same time, different functions can be implemented by one hardware structure, or can be implemented by a plurality of hardware structures. The execution order of the method of the present invention is not limited to the described order, and can be executed concurrently or in other order.

Thus the present invention includes an apparatus for dynamically assembling a business process model. The model being configured in a company terminal connected with a network, and having a model building unit for building a first business process model for the company. The apparatus is characterized in that it comprises: a retrieving unit for retrieving a second business process model of another company from the network; and an assembling unit for assembling the first business process model of the company with said second business process model to form an integrated business process model.

The above are only examples of advantageous embodiments of the present invention and ought not be used to limit the scope claimed by the present invention. Those skilled in the art recognize that, various modification or changes can be made according to the embodiment of the present invention, all of which belong to the scope claimed by the present invention, without departing from the spirit and scope of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or after reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An apparatus for dynamically assembling a business process model, which being configured in a company terminal connected with a network, and having a model building unit for building a first business process model for the company, characterized in that the apparatus comprising:
a retrieving unit for retrieving a second business process model of another company from the network; and
an assembling unit for assembling the first business process model of the company with said second business process model to form an integrated business process model.

2. The apparatus according to claim 1, further comprising:
a conflict detecting unit for simulating and analyzing the integrated business process model to detect whether or not there is a conflict therein, and generating a conflict report when there is a conflict in the integrated business process model.

3. The apparatus according to claim 2, further comprising:
a conflict solving auxiliary unit for transmitting and/or receiving the conflict report to and/or from said another company through the network, so as to facilitate the negotiation and solving of the conflict.

4. The apparatus according to claim 1, further comprising:
a publishing unit for publishing the business process model of the company over the network.

5. The apparatus according to claim 4, characterized in that the publishing unit publishes the business process model of the company onto a UDDI registry in the network, and the retrieving unit retrieves and obtains from the UDDI registry the business process model of said another company.

6. A method of dynamically assembling a business process model, for building a business process model for a company in the company's network terminal, characterized in that the method comprises:
a retrieving step of retrieving in the network to obtain the business process model of other company; and
an assembling step of assembling the business process model of the company with that of said another company to obtain an integrated business process model.

7. The method according to claim 6, further comprising:
a conflict detecting step of simulating and analyzing the integrated business process model to detect whether or not there is a conflict therein, and generating a conflict report when there is a conflict in the integrated business process model.

8. The method according to claim 7, further comprising:
a conflict solving auxiliary step of transmitting and/or receiving the conflict report to and/or from said another company through the network, so as to facilitate the negotiation and solving of the conflict.

9. The method according to claim 6, further comprising:
a publishing step of publishing the business process model of the company over the network.

10. The method according to claim 9, characterized in that the publishing step publishes the business process model of the company onto a UDDI registry in the network, and the retrieving step retrieves and obtains from the UDDI registry the business process model of said another company.

11. A system for dynamically assembling a business process model in a large scale
e-business network, comprising a plurality of apparatuses for dynamically assembling a business process model, which being configured in a plurality of company terminals connected through a network and having a model building unit for building a business process model for the company configured with the apparatus, characterized in that the apparatus further comprises:
a retrieving unit for retrieving to obtain the business process model of another company from the network;
an assembling unit for assembling the business process model of the company with that of said another company to obtain an integrated business process model;
a conflict detecting unit for simulating and analyzing the integrated business process model to detect whether or not there is a conflict therein, and generating a conflict report when there is a conflict in the integrated business process model; and
a conflict solving auxiliary unit for transmitting and/or receiving the conflict report to and/or from said another company through the network, so as to facilitate the negotiation and solving of the conflict.

12. The system according to claim 11, further comprising:
a publishing unit for publishing the business process model of the company over the network.

13. The system according to claim 11, characterized in that the publishing unit publishes the business process model of the company onto a UDDI registry in the network, and the retrieving unit retrieves and obtains from the UDDI registry the business process model of said another company.

14. A computer program product comprising a computer usable medium having computer readable program code means embodied therein for causing functions of an apparatus for dynamically assembling a business process model, the computer readable program code means in said computer program product comprising computer readable program code means for causing a computer to effect the functions of claim 1.

15. A computer program product comprising a computer usable medium having computer readable program code means embodied therein for causing functions of a system for dynamically assembling a business process model, the computer readable program code means in said computer program product comprising computer readable program code means for causing a computer to effect the functions of claim 11.

16. A computer program product comprising a computer usable medium having computer readable program code means embodied therein for causing functions of a system for dynamically assembling a business process model, the computer readable program code means in said computer program product comprising computer readable program code means for causing a computer to effect the functions of claim 13.

17. An article of manufacture comprising a computer usable medium having computer readable program code means embodied therein for causing dynamic assembly of a business process model, the computer readable program code means in said article of manufacture comprising computer readable program code means for causing a computer to effect the steps of claim 6.

18. A program storage device readable by machine, tangibly embodying a program of instructions executable by the machine to perform method steps for dynamically assembling a business process model, said method steps comprising the steps of claim 6.

19. An article of manufacture comprising a computer usable medium having computer readable program code means embodied therein for causing dynamic assembly of a business process model, the computer readable program code means in said article of manufacture comprising computer readable program code means for causing a computer to effect the steps of claim 3.

20. A program storage device readable by machine, tangibly embodying a program of instructions executable by the machine to perform method steps for dynamically assembling a business process model, said method steps comprising the steps of claim 8.
